(19) United States
(12) Patent Application Publication
(10) Pub. No.: US 2024/0373988 A1
(43) Pub. Date: Nov. 14, 2024

(54) SEAT BELT TONGUE AND SEAT BELT DEVICE

(71) Applicant: AUTOLIV DEVELOPMENT, Vargarda (SE)

(72) Inventors: Larissa MELNIKOVA, Tallinn (EE); Aidu OTS, Tallinn (EE)

(21) Appl. No.: 18/692,429

(22) PCT Filed: Sep. 2, 2022
(86) PCT No.: PCT/EP2022/074416

§ 371 Date: Mar. 15, 2024

(30) Foreign Application Priority Data
Sep. 16, 2021 (DE) 10 2021 210 252.2

(51) Int. Cl. A44B 11/25

(52) U.S. Cl. CPC A44B 11/2561

(57) ABSTRACT

A seat belt tongue having a main body, a covering which at least partially covers the outside of the main body, and at least one electronic component which is arranged between the main body and the covering, wherein the electronic component is arranged on a carrier part, and the carrier part is pre-fixed to the main body by means of a form-fitting design.

The present invention relates to a seat belt tongue having the features of the preamble of Claim 1, a seat belt device having the features of the preamble of Claim 10, and a production method for a seat belt tongue having the features of the preamble of Claim 12.

In seat belt devices, different electrical or electronic components, such as, for example, microphones can be provided in the seat belt for additional functions. These components must be supplied with electrical power for permanent operation. The connection of a microphone in the seat belt is known, for example, from DE 10 2005 002 865 B3.

In the case of three-point seat belts, one end of the seat belt is usually

fastened to a fastening element, usually referred to as an anchor plate, at a fixed attachment point on the vehicle structure or the vehicle seat, where the coupling of the necessary electrical conductors can take place in a simple manner.

Furthermore, a seat belt device with an electronic device is known from DE 10 2019 103 460 A1, in which energy is inductively transmitted to a corresponding receiving unit in the belt strap via a transmitter unit arranged outside the belt strap. In this case, a plurality of offset coils as transmitting and/or receiving unit can be used to compensate for the position of the belt strap during use.

Furthermore, in the yet unpublished patent application DE 10 2020 133 574.1 of the applicant, a seat belt device for motor vehicles is described which has a belt buckle with an insertion slot, a seat belt tongue which can be inserted into and locked in the insertion slot of the belt buckle, and a seat belt. The seat belt tongue itself has a main body and a covering, and the seat belt extends through a bracket of the seat belt tongue. Furthermore, the belt buckle and the seat belt tongue are adapted to transmit electrical power and/or signals from the belt buckle to the seat belt tongue.

A transmission of electrical power and/or signals from the belt buckle to the seat belt tongue and vice versa allows for a corresponding transmission of the power or of the signals without a fixed attachment point of the seat belt device on the vehicle structure or on the vehicle seat being necessary. This means that the signals and/or the power can also be transmitted in seat belt devices with so-called double retractors which, in the case of a three-point belt for shoulder and lap belt, each have separate retractors, so that the seat belt does not have to have a fixed attachment point on the vehicle structure or on the vehicle seat. In this case, the signals or power are transmitted via the belt buckle fastened to the vehicle structure or to the vehicle seat onto the seat belt tongue locked therein and vice versa.

In DE 10 2020 133 574.1, an inductor coil is provided for transmitting the signals to the seat belt tongue. The seat belt tongue has a main body, for example, in the form of a metal plate, which is covered on both sides by two covering parts of a two-part seat belt tongue covering. One of the covering parts has a receptacle for receiving the inductor coil and the electrical plug connection. The inductor coil and the electrical plug connection are then fixed between the two parts after fastening the covering part to the main body.

In order to assemble the seat belt tongue, four steps are thus required, inserting the inductor coil and inserting the electrical plug connection into the corresponding receptacles of the covering part and connecting the two covering parts to the main body, wherein, when connecting the covering parts, it must be ensured that the inductor coil and the electrical plug connection do not unintentionally slip out of the receptacles or their predetermined position. Overall, this results in a complex assembly process.

Against this background, the invention is based on the object of creating a seat belt tongue with at least one electronic component and an assembly method for such a seat belt tongue, which can be assembled in a reliable manner with a lower assembly effort, or which makes it possible to assemble the seat belt tongue with reduced effort.

To achieve the object, a belt buckle having the features of Claim 1 and a seat belt device having the features of Claim 10 and a production method having the features of Claim 12 are proposed. Further preferred developments of the invention can be taken from the dependent claims, the figures and the associated description.

According to Claim 1, a seat belt tongue having a main body, a covering which at least partially covers the outside of the main body, and at least one electronic component which is arranged between the main body and the covering is proposed to achieve the object, wherein the basic idea of the invention is that the electronic component is arranged on a carrier part, and the carrier part is pre-fixed to the main body by means of a form-fitting design.

The invention is thus based on two steps by the electronic component being initially arranged on a carrier part, which is thus designed independently of the electronic component, for example, by its shape, for holding the electronic component. In the second step, the electronic component is therefore not held in a receptacle of the covering, but instead the carrier part is formed individually independently of the electronic component for prefixing to the main body of the seat belt tongue. The carrier part thus forms a structural interface between the main body and the electronic component for prefixing the electronic component to the main body. This means that, the covering can then be applied in a simplified method without having to consider the loss security of the electronic component, as was previously the case. Instead, the electronic component is held on the main body of the seat belt tongue during the application of the covering over the carrier part, so that the application of the covering with respect to this assembly or manufacturing step can be optimized without having to consider the electronic component. After the covering is applied, the electronic component is then held between the covering and the main body of the seat belt tongue in addition to the prefixing of the carrier part to the main body.

It is further proposed that at least one electrical contact and an electrical line connecting the electrical contact to the electrical component is provided on the carrier part. An external electrical contacting of the electronic component is made possible by the electrical contact and the electrical line.

It is further proposed that the electronic component, the electrical contact, and the electrical line are arranged on the carrier part as a prefabricated composite component. The composite component with the electronic component, the electrical contact, and the electrical line can thus also be understood as a prefabricated electronic assembly which is then prefixed on the carrier part in a first assembly step, subsequently in a second assembly step together with the carrier part on the main body, and is covered in a third assembly or manufacturing step by the covering to the outside.

It is further proposed that the carrier part has a shape adapted to the outer shape of the main body. Due to the proposed design, the carrier part is designed in such a way that it joins the main body to form a compact space-optimized shape. The carrier part can be shaped, for example, in such a way that it deliberately utilizes free spaces on the main body for its arrangement, and is thereby additionally pre-positioned with respect to the main body. Furthermore, the planar shape of the carrier part can also be adapted to the main body, by, for example, openings or radii of the main body in the shape of the carrier part being repeated, or by the carrier part resting flat against the main body.

It is further proposed that the electronic component and/or the electrical contact and/or the electrical line is/are arranged on the side of the carrier part facing the main body of the seat belt tongue. Due to the proposed arrangement, the electronic component and/or the electrical contact and/or the electrical line is/are covered by the carrier part toward the side of the covering and thus additionally protected from mechanical effects during the application of the covering. Furthermore, the carrier part can thereby be handled from the side on which the electronic component is not arranged during placement on the main body, which can further simplify the assembly process. In addition, the probability of damage to the electronic component, the electrical line, and/or the contact during assembly can thereby be reduced.

It is further proposed that the carrier part is a flat component with a shape adapted to the surface of the main body. The main body is thus thickened in the region of the carrier part by the thickness of the carrier part. In addition, the carrier part is thereby supported by the main body in a mechanically stable manner.

It is further proposed that the main body has at least two openings which

are separated from one another by a web, and the openings are thickened at least in the region of the edge sides delimiting the web, and the carrier part is pre-fixed in a form-fitting manner at least between the thickened edge sides of the openings on the main body. The openings and the web arranged therebetween with the thickened edge sides of the openings create a practical clamping surface to which the support section can be clipped. The openings can be used, for example, to form one or two webs for holding one or more belt strap ends in the form of belt strap loops. The openings and the web provided therebetween are thus designed to be elongated, each with two elongated longitudinal sides running parallel.

It is further proposed that the covering is formed by injection-molding. The advantage of this solution can be seen in the fact that the carrier part with the electronic component is thereby held in a particularly compact and fixed manner on the main body, in particular, without play and rattling. In addition, the seat belt tongue can thereby be provided with the covering in a particularly cost-effective manner in large quantities in a plastic injection molding process. The carrier part is conveniently pressed against the main body of the seat belt tongue by the injection-molding of the covering part, wherein the carrier part is held in position by its prefixing on the main body during the injection process.

Furthermore, a seat belt device having such a seat belt tongue is proposed for achieving the object, which seat belt device has two belt retractors, on each of which a belt portion can be wound with a first end, and that the belt portions are connected to the seat belt tongue with a respective second end. The seat belt device thus has two belt portions which can be wound independently of one another and are separated from one another and which are held with their second ends on the seat belt tongue according to the invention.

It is further proposed that a belt buckle is provided which has a second electronic component interacting with the electronic component of the seat belt tongue. The belt buckle is fastened in a vehicle-mounted manner either to a vehicle seat or to the vehicle structure and can thereby be electronically connected to a vehicle-mounted electronic data processing device without a moving point having to be bridged for this purpose. The second electronic component in the belt buckle interacts with the electronic component of the seat belt tongue and forms the electronic interface between the electronic component of the seat belt tongue and the vehicle-mounted data processing device.

Furthermore, a production method for producing a seat belt tongue according to the invention is proposed for achieving the object, in which production method the carrier part is pre-fixed on the main body together with the electronic component, and the carrier part is then fixed between the main body and the covering by applying the covering, wherein according to a further preferred development it is proposed that the covering is applied by injection-molding.

The invention is explained below on the basis of preferred embodiments, with reference to the accompanying figures. In the figures:

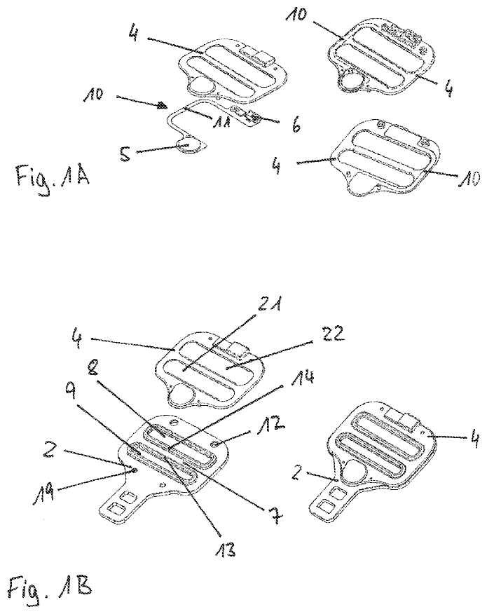

FIGS. 1A and 1B show a main body with a carrier part and a covering of a seat belt tongue according to the invention in an exploded view and in the assembled state; and

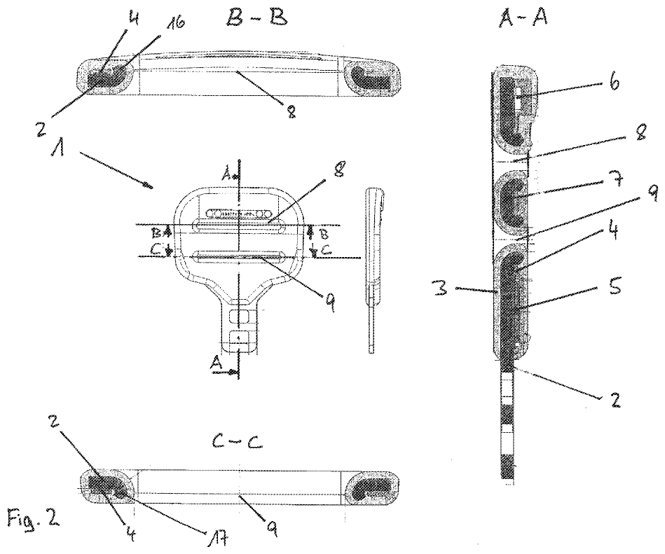

FIG. 2 shows a seat belt tongue according to the invention in different perspectives and sectional illustrations; and

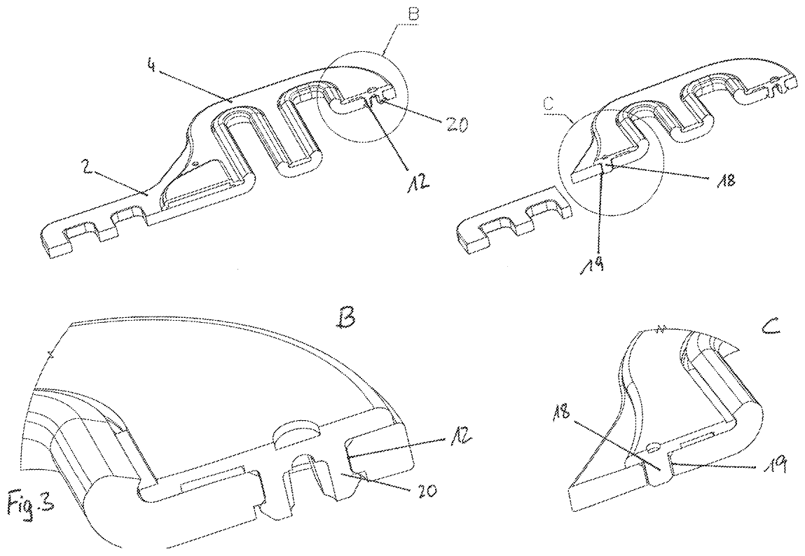

FIG. 3 shows a main body of the seat belt tongue with a carrier part in a first section; and

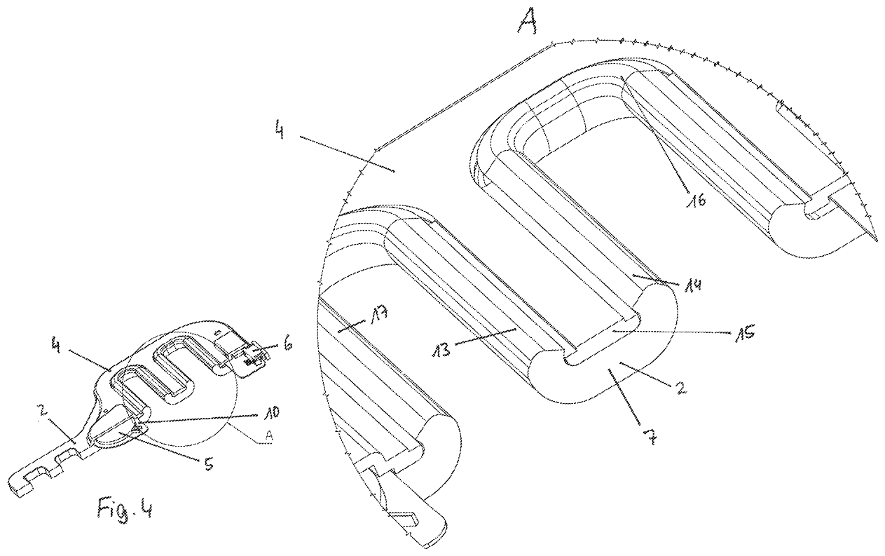

FIG. 4 shows a main body of the seat belt tongue with a carrier part in a second section; and

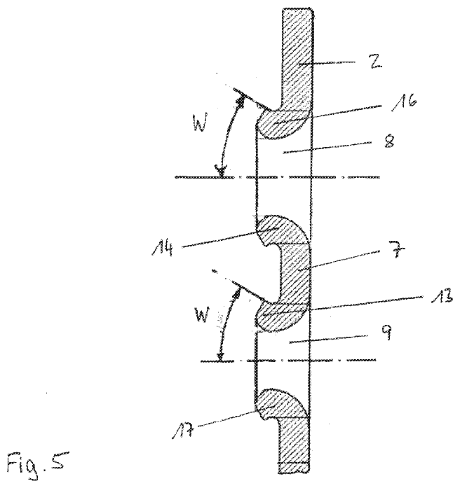

FIG. 5 shows a sectional view of the main body without a carrier part.

FIG. 1A shows in the upper illustration a carrier part 4 and a composite component 10 with an electronic component 5, for example, in the form of an inductor coil, an electrical contact 6, and an electrical line 11. The carrier part 4 has a receptacle which corresponds to the shape of the composite component 10 and into which the composite component 10 is inserted. The shape of the receptacle in the carrier part 4 is thereby adapted to the shape of the composite component 10 in such a way that the composite component 10 can be received therein both with its electronic component 5 and with the electrical contact 6 and the electrical line 11. In the right illustrations of FIG. 1A, the carrier part 4 can be seen from the upper side and the underside with the composite component 10 inserted.

The composite component 10 is a prefabricated component which has the electrical line 11, the electronic component 5 and the contact 6. The composite component 10 can additionally have a base part, for example in the form of a film, on which the electronic component 5, the electrical line 11 and the contact are held and fixed to one another. The base part predetermines the outer shape of the composite component 10 and is formed in the carrier part 4 corresponding to the outer shape of the receptacle. The receptacle in the carrier part 4 is thus closed toward its underside by the inserted composite component 10 to form a flat surface, as can be seen in the bottom right-hand illustration of the underside of the carrier part 4 of FIG. 1A.

In FIG. 1B, the carrier part 4 corresponding to the upper right-hand illustration of FIG. 1A can be seen with the inserted composite component 10, which cannot be seen, and a main body 2 in the form of a stamped metal plate. The main body 2 has two elongated parallel openings 8 and 9, each having an edge side 13 and 14, which enclose a web 7 between them. Furthermore, two pairs of latching openings 12 and 19 are provided on the upper side and the underside with respect to the openings 8 and 9 of the main body 2. The carrier part 4 is pre-fixed on the main body 2 together with the composite component 10 and the electronic component 5 held thereon by a form-fitting design explained in more detail below.

FIG. 2 shows a seat belt tongue 1 according to the invention with the

main body 2, the carrier part 4 and a covering 3 covering the carrier part 4 to the outside. The main body 2 is thickened at the edge sides 13 and 14 in that the edge sides 13 and 14 are each plastically deformed into a bead 16 and 17, as can also be seen in FIG. 4. The carrier part 4 also has two openings 21 and 22 which are dimensioned somewhat larger than the openings 8 and 9 of the main body 2. Furthermore, latching pins 18 and 20 which can be seen on the carrier part 4 in FIG. 3 are provided, which latching pins are arranged in the main body 2 corresponding to with the arrangement of the latching holes 12 and 19.

The carrier part 4 is now pre-fixed on the main body 2 together with the composite component 10 corresponding to the assembly step shown in FIG. 1B in that it is inserted with the latching pins 18 and 20 into the latching holes 12 and 19 and is clipped with the openings 21 and 22 via the thickened beads 16 and 17 of the edge sides 13 and 14 of the openings 8 and 9 of the main body 2. In the process, a form-fitting connection is realized both by the latching pins 18 and 20 and via the edge sides of the openings 20 and 21 behind the thickened edge sides 13 and 14 of the openings 8 and 9 of the main body 2, through which connection the carrier part 4 is subsequently pre-fixed to the main body 2. In the process, the carrier part 4 latches, in particular, with the strip 15, which is formed between the two openings 21 and 22 and can be seen in FIG. 4, on the web 7 of the main body 2 between the beads 16 and 17 of the edge sides 13 and 14 of the openings 8 and 9 of the main body 2.

The electronic component 5, the line 11 and the electrical contact 6 are arranged via the composite component 10 on the side of the carrier part 4 which, in the fastening position of the carrier part 4, faces the main body 2 of the seat belt tongue 1. The electronic component 5, the line 11 and the contact 6 are thus covered by the carrier part 4 to the outside and are thereby additionally protected from mechanical effects when the covering 3 is applied.

In this case, the covering 3 is preferably realized by a plastic injection-molding, i.e., the main body 2 is inserted with the carrier part 4 held thereon as a preassembled assembly with the composite component 10, the electronic component 5 arranged thereon, the line 11, and the contact 6 into the injection-molding tool and injection-molded with the plastic. Subsequently, the plastic injection-molding forms a fixed casing of the main body 2 with the carrier part 4 which is secured in between and is fixed in a rattle-free manner. However, it is equally conceivable to form the covering 3 from two or more covering parts which can be connected to one another and to the main body 2, for example by a clip connection.

In the present embodiment, the electronic component 5 is realized by an inductor coil which is positioned on the seat belt tongue 1 so that, when the seat belt tongue 1 is locked in a belt buckle, it comes to overlap with a second electronic component in the form of a further inductor coil held on the belt buckle. A signal is thereby generated which makes it possible to deduce the locking state of the seat belt tongue 1 in the belt buckle. Furthermore, the electronic component 5 of the seat belt tongue is therefore opposite the second electronic component on the belt buckle, so that signals and possibly also electrical power can be transmitted via this. For this purpose, the electronic components 5 can also be designed differently from the inductor coils or comprise additional components.

FIG. 5 shows the main body 2 as a single part in a sectional view. The beads 16 and 17 of the edge sides 13 and 14 are preferably formed by bending the edge sides 13 and 14 at an angle W of 10 to 45 degrees preferably of 30 degrees to the center axes running through the openings 8 and 9. The bending of the edge sides 13 and 14 can be integrated into the stamping process, for example, in that the openings 8 and 9 are first stamped with a smaller opening width and the edge sides 13 and 14 are then formed in a second step by means of a stamp with a slightly larger dimension by a plastic deformation to form the beads 16 and 17.

1. A seat belt tongue comprising:
a main body,
a covering which at least partially covers the main body to the outside; and,
at least one electronic component arranged between the main body and the covering, wherein
the electronic component is arranged on a carrier part, and
the carrier part is pre-fixed to the main body via a form-fitting design.

2. The seat belt tongue according to claim 1, wherein
at least one electrical contact and an electrical line connecting the electrical contact to the electrical component are provided on the carrier part.

3. The seat belt tongue according to claim 2, wherein
the electronic component, the electrical contact and the electrical line are arranged on the carrier part as a prefabricated composite component.

4. The seat belt tongue according to claim 1, wherein
the carrier part has a shape adapted to the outer shape of the main body.

5. The seat belt tongue according to claim 1, wherein
the electronic component and/or the electrical contact and/or the electrical line is or are arranged on the side of the carrier part facing the main body of the seat belt tongue.

6. The seat belt tongue according to claim 1, wherein
the carrier part is a flat component with a shape adapted to the surface of the main body.

7. The seat belt tongue according to claim 1, wherein
the main body has at least two openings which are separated from one another by a web, and
the openings are thickened at least in the region of the edge sides delimiting the web, and
the carrier part is fixed in a form-fitting manner at least between the thickened edge sides of the openings on the main body.

8. The seat belt tongue according to claim 7, wherein
the edge sides are formed into thickened beads at an angle W of 10 to 45 degrees, preferably at an angle W of 30 degrees to a central axis of the openings.

9. The seat belt tongue according to claim 1, wherein
the covering is formed by injection-molding.

10. A seat belt device comprising a seat belt tongue according to claim 1, wherein
the seat belt device has two belt retractors, on each of which a belt portion can be wound with a first end, and that the belt portions are each connected to the seat belt tongue with a second end.

11. The seat belt device according to claim 10, wherein
a belt buckle is provided which has a second electronic component interacting with the electronic component of the seat belt tongue.

12. A production method for producing a seat belt tongue according to claim 1, wherein
the carrier part is pre-fixed to the main body together with the electronic component, and
the carrier part is then finally fixed between the main body and the covering by applying the covering.

13. The production method according to claim 12, wherein
the covering is applied by injection-molding.
